(19) United States
(12) Patent Application Publication
(10) Pub. No.: US 2023/0195838 A1
(43) Pub. Date: Jun. 22, 2023

(54) DISCOVERING DISTRIBUTION SHIFTS IN EMBEDDINGS

(71) Applicant: Microsoft Technology Licensing, LLC, Redmond, WA (US)

(72) Inventors: Leo Moreno BETTHAUSER, Kirkland, WA (US); Urszula Stefania CHAJEWSKA, Issaquah, WA (US); Maurice DIESENDRUCK, Bellevue, WA (US); Rohith Venkata PESALA, Redmond, WA (US)

(21) Appl. No.: 17/556,642

(22) Filed: Dec. 20, 2021

(51) Int. Cl. G06K 9/62

(52) U.S. Cl. CPC G06K 9/6232; G06K 9/6215; G06K 9/627; G06K 9/6255

(57) ABSTRACT

The monitoring of performance of a machine-learned model for use in generating an embedding space. The system uses two embedding spaces: a reference embedding space generated by applying an embedding model to reference data, and an evaluation embedding space generated by applying the embedding model to evaluation data. The system obtains multiple views of the reference embedding space, and uses those multiple views to determine a distance threshold. The system determines a distance between the evaluation and reference embedding spaces, and compares that distance with the fitness threshold. Based on the comparison, the system determines a level of acceptability of the model for use with the evaluation dataset.

### BACKGROUND

In recent years, the field of artificial intelligence has made significant progress in many applications due to the introduction and refinement of representation machine-learning (ML) models. These representation learning models produce vector representations of input data. Each vector representation is also referred to as an “embedding”. Since each vector generally has multiple dimensions, a collection of embeddings forms a multi-dimensional space, also referred to as an “embedding space”. When many embeddings are present within the embedding space, a point cloud of embeddings is typically present within the embedding space.

While the number of dimensions in the embedding space is predetermined prior to training, the machine learning itself chooses the meaning of each dimension. Such machine-generated dimension selection often result in dimensions that are not intuitive to or perhaps even understandable to a human user. Nevertheless, such embedding spaces can then be used in downstream tasks that do produce human understandable output. Such downstream tasks include similarity searching, classification, regression, language/image generation, and many others.

Representation learning models are trained on large datasets for specific modalities. As an example, a representation learning model may be trained on images; another representation learning model may be trained on text; yet another trained on video; and so forth. These pre-trained representation learning models may then be available (e.g., to the public) for further use. Accordingly, new input datasets may be processed through pre-trained models, resulting in different embedding spaces.

The subject matter claimed herein is not limited to embodiments that solve any disadvantages or that operate only in environments such as those described above. Rather, this background is only provided to illustrate one exemplary technology area where some embodiments describe herein may be practiced.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The principles described herein relate to the evaluation of a fit of a representation learning model for an evaluation dataset. Fitness may be lower than for a reference dataset because the evaluation dataset is not sufficiently similar to a reference dataset. Hereinafter, the terms “representation learning model” and “embedding model” will be used interchangeably. An embedding space is a multi-dimensional space generated by a machine, but which is typically not visible to a user. This embedding space often has more (and often many more) than three dimensions. Furthermore, the mapping from input data to embedding values for each dimension are selected by the model during training, and the meanings of the dimensions are typically hidden to the user, and may be difficult to understand. Nevertheless, the representation learning model chooses the mapping to provide a good embedding space for use in providing point clouds upon which the machine can effectively operate and make machine-inferences (such as classification, similarity analysis, and so forth) that are more understandable and relatable by a human being.

This evaluation may be performed without even having access to the embedding model, and without relying on human feedback. Furthermore, distribution shifts may be identified quickly enough to avoid widespread harm resulting from degraded performance of tasks that are downstream of the embedding space. For instance, by avoiding the use of embedding spaces with too much distribution shift from a prior reliable embedding space, the principles described herein avoid improper similarity results, inaccurate classification, imprecise regression, and low quality or inaccurate language or image generation.

In accordance with the principles described herein, the embedding space is analyzed to determine if the embedding model is fit for use with an evaluation dataset. The computing system uses two embedding spaces: a reference embedding space and an evaluation embedding space. The reference embedding space is an embedding space generated by applying the embedding model to a reference dataset. The evaluation embedding space is generated by applying the embedding model to an evaluation dataset. The object is to determine whether the embedding model is still acceptable given that the evaluation dataset is different than the reference dataset.

The computing system obtains multiple views of the reference embedding space, and uses those multiple views to determine a distance threshold. The computing system determines a distance value representing a distance between the evaluation embedding space and the reference embedding space. The computing system thereafter compares that distance value with the distance threshold. Based on the comparison, the computing system determines a level of fitness of the embedding model for the evaluation dataset.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and details through the use of the accompanying drawings in which:

FIG. 1 illustrates an example process of training a machine learning environment having an embedding model and a downstream task models;

FIG. 2 illustrates an example of a three-dimensional chart that represents a populated three-dimensional space of embeddings (which may correspond to the embedding space of FIG. 1);

FIG. 3 illustrates an environment in which a model fitness component operates, and in which the principles described herein may operate;

FIG. 4 illustrates a flowchart of a method for a computing system to determine a level of fitness of an embedding model for an evaluation dataset, in accordance with the principles described herein;

FIG. 5 illustrates various data flows associated with the model fitness component analyzing the reference embedding space and the evaluation embedding space to make a determination as to fitness of the embedding model for the evaluation dataset;

FIG. 6 illustrates distance and performance criteria graphed against perturbation noise used to explain a first pseudocode example; and

FIG. 7 illustrates an example computing system in which the principles described herein may be employed.

### DETAILED DESCRIPTION

The principles described herein relate to the evaluation of a fit of a representation learning model for an evaluation dataset. Fitness may be lower than for a reference dataset because the evaluation dataset is not sufficiently similar to a reference dataset. Hereinafter, the terms “representation learning model” and “embedding model” will be used interchangeably. An embedding space is a multi-dimensional space generated by a machine, but which is typically not visible to a user. This embedding space often has more (and often many more) than three dimensions. Furthermore, the mapping from input data to embedding values for each dimension are selected by the model during training, and the meanings of the dimensions are typically hidden to the user, and may be difficult to understand. Nevertheless, the representation learning model chooses the mapping to provide a good embedding space for use in providing point clouds upon which the machine can effectively operate and make machine-inferences (such as classification, similarity analysis, and so forth) that are more understandable and relatable by a human being.

This evaluation may be performed without even having access to the embedding model, and without relying on human feedback. Furthermore, distribution shifts may be identified quickly enough to avoid widespread harm resulting from degraded performance of tasks that are downstream of the embedding space. For instance, by avoiding the use of embedding spaces with too much distribution shift from a prior reliable embedding space, the principles described herein avoid improper similarity results, inaccurate classification, imprecise regression, and low quality or inaccurate language or image generation.

In accordance with the principles described herein, the embedding space is analyzed to determine if the embedding model is fit for use with an evaluation dataset. The computing system uses two embedding spaces: a reference embedding space and an evaluation embedding space. The reference embedding space is an embedding space generated by applying the embedding model to a reference dataset. The evaluation embedding space is generated by applying the embedding model to an evaluation dataset. The object is to determine whether the embedding model is still acceptable given that the evaluation dataset is different than the reference dataset.

The computing system obtains multiple views of the reference embedding space, and uses those multiple views to determine a distance threshold. The computing system determines a distance value representing a distance between the evaluation embedding space and the reference embedding space. The computing system thereafter compares that distance value with the distance threshold. Based on the comparison, the computing system determines a level of fitness of the embedding model for the evaluation dataset.

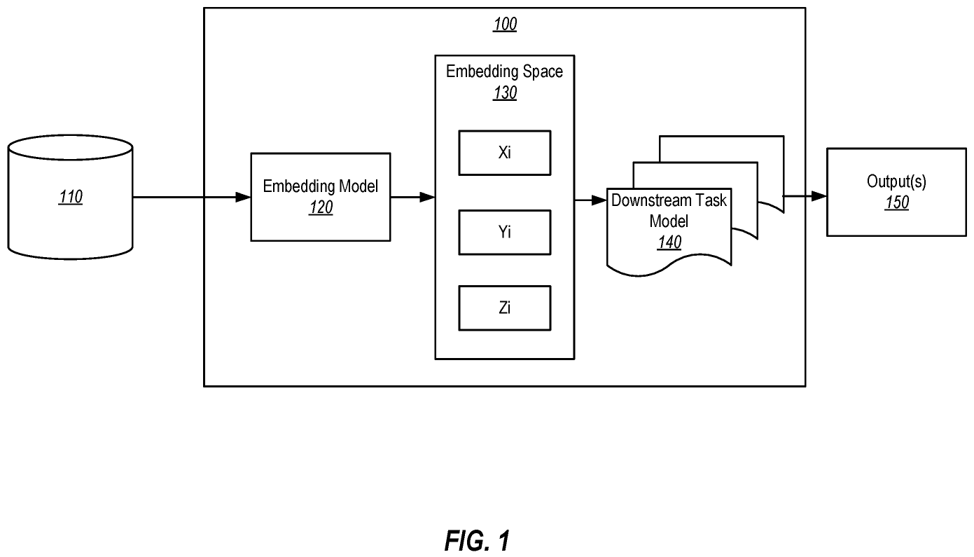

Many representation learning models for specific modalities (text, image, video, etc.) are pre-trained on large datasets, which may be general-purpose or domain-specific. FIG. 1 illustrates an example process of training a machine learning environment 100 having an embedding model 120 and a downstream task model 140. As illustrated in FIG. 1, a training dataset 110 is fed into an embedding model 120 configured to extract an embedding space 130 having multiple embeddings. Each embedding is a vector representation of each data item in the training dataset 110. The embedding model 120 is a representation learning model.

The embedding or vector representation can be any dimensional. For example, if the embeddings are three-dimensional, each embedding can be represented by three values (xᵢ, yᵢ, zᵢ). For example, the first data item in the training dataset is represented by embedding (x₁, y₁, z₁); the second data item in the training dataset is represented by embedding (x₂, y₂, z₂), and so on and so forth. As such, all the data items in the training dataset form an embedding space 130. It is common for embedding spaces to have many dimensions, such as tens or hundreds. Thus, it is difficult, if not impossible, for human users to visualize even an empty unpopulated embedding space of so many dimensions.

The embedding space 130 is then processed by a downstream task model 140 trained to perform one or more downstream tasks using the embedding space. The downstream task model 140 generates one or more outputs 150 as a result. The downstream task model 140 can be configured or trained for many different purposes, such as (but not limited to) classification, anomaly detection, and so forth. For example, suppose the downstream task model 140 is configured or trained to be a classifier. In that case, the downstream task model 140 is configured to classify each new input data item into one of a plurality of classes. As another example, suppose the downstream task model 140 is trained to be an anomaly detector. In that case, the downstream task model 140 is configured to determine whether each new input data item is anomalous.

As illustrated in FIG. 1, the trained machine learning environment 100 includes an embedding model 120 configured to extract an embedding space for its training dataset. The embedding model 120 can also be used to extract a space of embeddings for a given dataset.

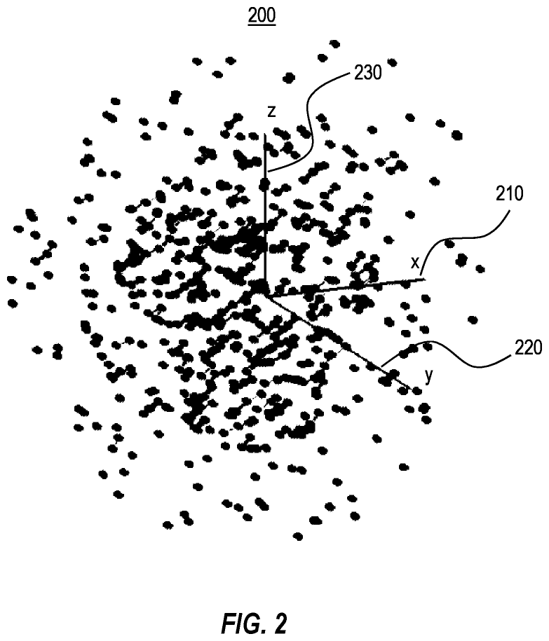

In some embodiments, a populated embedding space (extracted from a training dataset or a user dataset) can be visualized in a multi-dimensional chart. FIG. 2 illustrates an example of a three-dimensional chart 200 that represents a populated three-dimensional space of embeddings (which may correspond to the embedding space 130 of FIG. 1). As illustrated in FIG. 2, the three-dimensional chart 200 includes an x-axis 210, a y-axis 220, and a z-axis 230, each of which represents one of three dimensions of the embedding space. The three-dimensional chart 200 also includes a plurality of points, each of which represents an embedding corresponding to a data item in a training dataset.

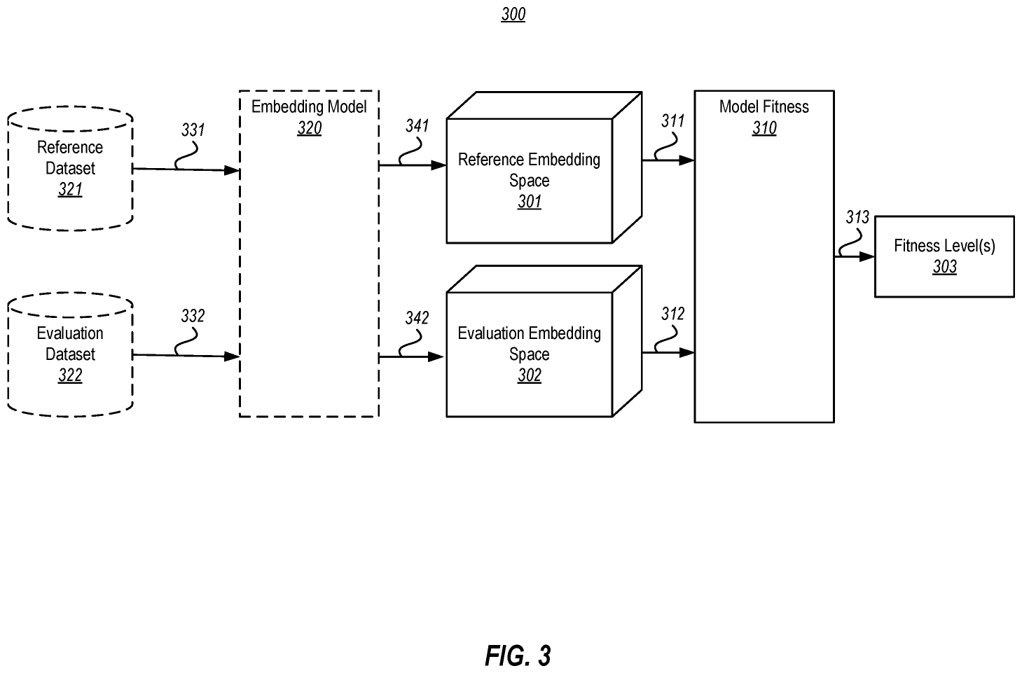

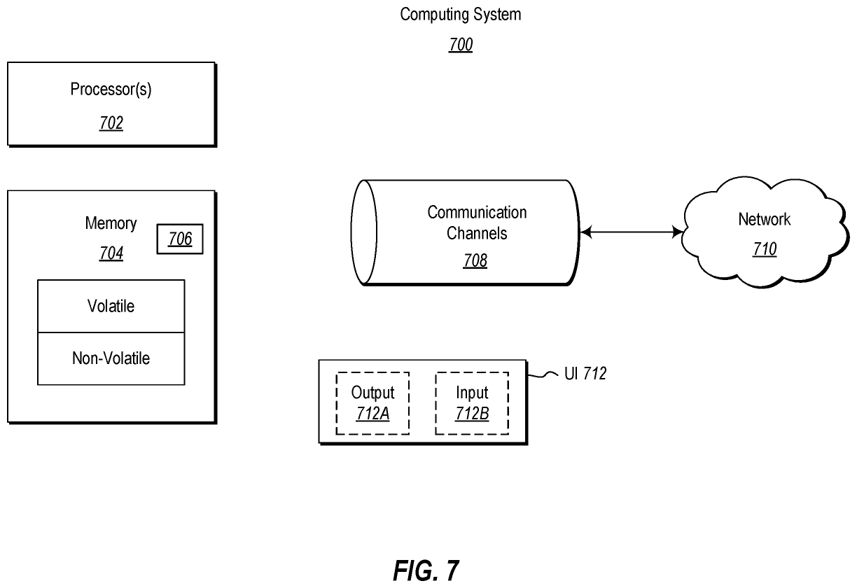

FIG. 3 illustrates an environment 300 in which a model fitness component 310 operates, and in which the principles described herein may operate. The model fitness component 310 accesses two embedding spaces. Specifically, the model fitness component 310 accesses (as represented by arrow 311) a reference embedding space 301 and (as represented by arrow 312) an evaluation embedding space 302. The model fitness component 110 outputs (as represented by arrow 313) one or more fitness levels 303. The environment 100 may be present on a computing system, such as the computing system 700 described below with respect to FIG. 7. In an example implementation, the model fitness component 110 is structured as described below for the executable component 706 of FIG. 7.

When there is but one fitness level 303, the output may be a binary result of whether or not the embedding model is acceptable for use with the evaluation dataset. This allows for a simple result of a complex process to be presented in a way that can be understood by a human being. This also allows for the decision to be easily processed by a computing system, thus preserving processing cycles involved with a computing system acting based on the binary result. Alternatively, the output may have multiple levels of fitness. This allows a computing system to take action based on a dataset approaching unfitness for a given embedding model, but yet still being fit for the time being. Such action could include obtaining and evaluating new embedding models in advance that may be more suitable given the direction that the input datasets are trending.

The portions of FIG. 3 that are shown in dotted-lined form represent components and dataset that need not be accessible within the environment 300. Rather, the model fitness component 310 can operate directly on the reference embedding space 301 and the evaluation embedding space 302. Nevertheless, the components and datasets are shown in dotted-lined form to show how embedding spaces 301 and 302 at some time came into being.

The reference embedding space 301 was previously generated (as represented by arrow 341) by applying an embedding model 320 to a reference dataset 321 (as represented by arrow 331). As an example, the embedding model 320 may be the embedding model 120 of FIG. 1. The embedding model 320 is suitable for generating an embedding space from the reference dataset 321. Thus, the reference embedding space 301 is a suitable embedding space for subsequent use in performing downstream tasks. The reference embedding space and the evaluation embedding space each have a same number of dimensions and same corresponding dimensions because each are generated using the same embedding model.

For instance, if the reference dataset was the training dataset itself, the embedding model 320 would clearly be suitable for generating the reference embedding space (i.e., the training embedding space in the case of training). In the case of the reference dataset 321 being the training dataset and the embedding model 320 being the embedding model 120 of FIG. 1, the reference dataset 321 would be the training dataset 110 of FIG. 1 and the reference embedding space 301 would be the embedding space 130 of FIG. 1. However, the reference dataset 321 does not need to be the training dataset, but may be another dataset for which the embedding model 320 is suitable for generating an embedding space.

As also represented in dotted-lined form in FIG. 3, the evaluation embedding space 302 was generated (as represented by arrow 342) by applying the embedding model 320 to an evaluation dataset 322 (as represented by arrow 332). The embedding model 320 is not known to be acceptable for generating an embedding space using the evaluation dataset 322. The technical effect of the embodiment of FIG. 3 is that a computing system can automatically determine directly from embedding spaces whether a proper and useful embedding space can be generated by the embedding model 320 on the evaluation dataset 322. Furthermore, because this can be determined directly from embedding spaces, the embedding model 320 is not even needed to determine whether the embedding model 320 is fit to operate on the evaluation dataset 322.

As previously mentioned, the dotted lines representing reference dataset 321, evaluation dataset 322 and the embedding model 320 symbolically represent that the fitness analytics can be performed without having access to the embedding model 320 itself, but by simply using prior output (embedding spaces) generated by the embedding model 320. The fitness analysis is performed without human feedback, and thus can be applied quickly. This means that when the datasets to be processed by an embedding model vary too much, this can be discovered automatically, thereby quickly avoiding degradation of downstream task performance.

The fitness level(s) 303 generated by the model fitness component 310 represents whether and/or how acceptable that embedding model 320 is in operating upon the evaluation dataset 322 as input. Fitness may be lower than for the reference dataset 321 because the evaluation dataset 322 is not sufficiently similar to the reference dataset 321. This is done by determining distance between the evaluation embedding space 302 and the reference embedding space 301. In other words, this is done by determining the distance between the point cloud represented by the embeddings generated from the evaluation dataset 322 and the point cloud represented by the embeddings generated from the reference dataset 321.

In this description and in the claims, “distance” is used generally to mean any function that when a distance metric of the distance increases, a performance criteria of the evaluation embedding space decreases. One example of a “distance” is an energy distance. As the energy distance increases, the performance criteria of the evaluation dataset decreases.

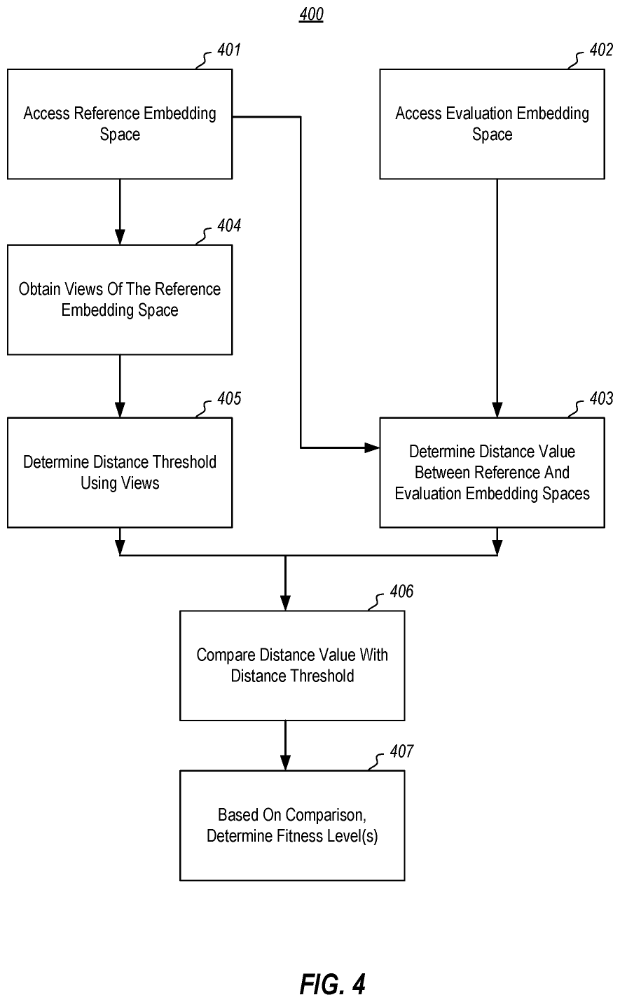

FIG. 4 illustrates a flowchart of a method 400 for a computing system to determine a level of fitness of an embedding model for an evaluation dataset, in accordance with the principles described herein. The method 400 may be performed by the model fitness component 310 of FIG. 3. The method 400 may be performed by the model fitness component 310 of FIG. 3 for example, in response to a computing system executing one or more computer-readable executable instructions that are embodied on a computer-readable media and that are structure such that, when executed by one or more processors of the computing system, cause the computing system to instantiate and/or operate the model fitness component 310.

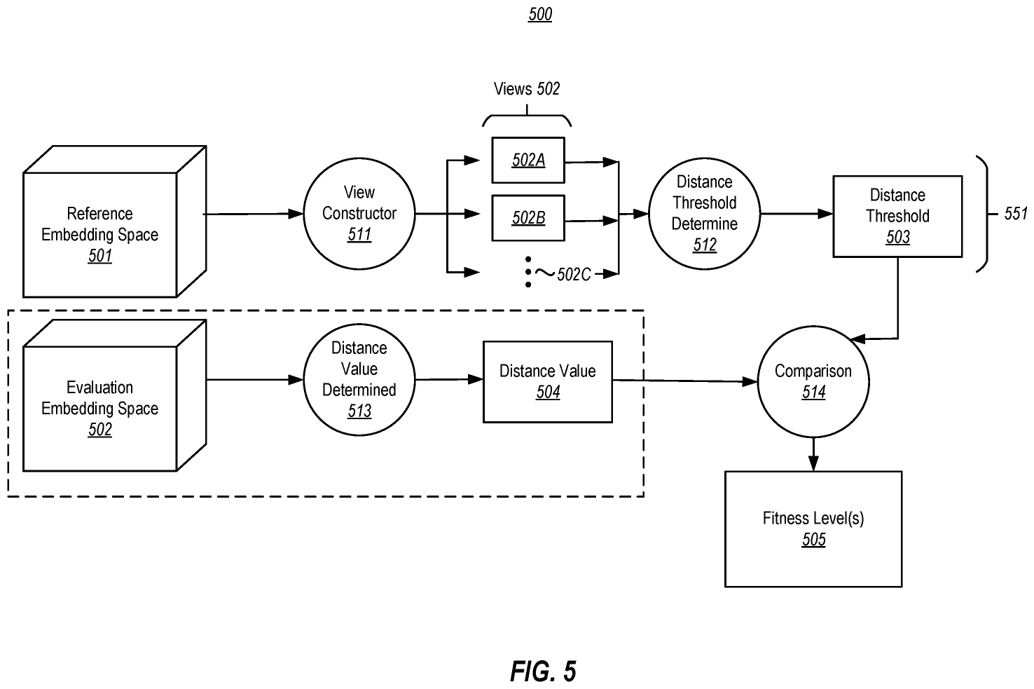

FIG. 5 illustrates various data flows 500 associated with the model fitness component 310 analyzing the reference embedding space and the evaluation embedding space to make a determination as to fitness of the embedding model 320 for the evaluation dataset 322. The various data flows 500 of FIG. 5 show one example of how the model fitness component 310 determines fitness level(s) from the reference embedding space 301 and the evaluation embedding space 302.

Referring to FIG. 4, the method 400 operates upon two embedding spaces including a reference embedding space and an evaluation embedding space. Accordingly, the method 400 includes accessing a reference embedding space generated by an embedding model using a reference dataset (act 401), and accessing an evaluation embedding space also generated by the embedding model but using an evaluation dataset (act 402). As an example, referring to FIG. 5, the data flow 500 begins with the reference embedding space 501 and the evaluation embedding space 502 being provided as input. The reference embedding space 501 is an example of the reference embedding space 301 of FIG. 3. The evaluation embedding space 502 is an example of the evaluation embedding space 302 of FIG. 3.

From there, one sub-flow 551 thereafter proceeds to determining a distance threshold, and another sub-flow 552 proceeds to determine a distance value. First, the sub-flow 551 that determines the distance threshold will be described. Specifically, in FIG. 4, a plurality of views of the reference embedding space are obtained (act 404). Then, the distance threshold is determined using the plurality of views of the reference embedding space (act 405). In FIG. 5, for example, the view constructor 511 constructs views 502 on the reference embedding space 501. The views 502 include at least two views 502A and 502B, but may include further views as well as represented by the ellipsis 502C. In this description, a “view” of data is any variation of the data that are caused by applying a transformation. Examples of the transformation includes perturbation (e.g., noise addition) and subsampling. The fitness threshold determination component 512 then determines the distance threshold 502 using the views 502 of the reference embedding space 501.

Next, the sub-flow 552 that determines the distance (as one example, an energy distance) between the embedding spaces will be described. Referring to FIG. 4, a distance is determined between the evaluation embedding space and the reference embedding space (act 403). In FIG. 5, for example, the distance determination component 513 determines a distance 504 between the reference embedding space 501 and the evaluation embedding space 502. As an example, a distance represents a distance between the point cloud of the reference embedding space 501 and the point cloud of the evaluation embedding space 502.

The result of the sub-flow 551 is used to determine the performance threshold level. We then use the view(s) with highest perturbation level that meet the performance threshold to determine maximum distance that does not indicate a distribution shift. The distance from the view(s) with highest perturbation level still meeting performance criteria to the reference embedding space is computed. If we are using multiple views, the distances from each of them to the reference dataset are aggregated using a suitable statistic (for example, a median). The distance value resulting is called a distance star or a distance threshold. Referring to FIG. 4, the distance value between the evaluation dataset and the reference dataset is then compared with the distance threshold (act 406). Based on that comparison, the level(s) of fitness of the embedding model for the evaluation dataset is determined (act 407). In FIG. 5, for example, the comparison component 514 compares the distance threshold 503 and the distance value 504. Furthermore, based on that comparison, the comparison component 514 generates the fitness level(s) 505. The fitness level(s) 505 represent an example of the fitness level(s) 303 of FIG. 3.

Accordingly, what has been described is a computer-implemented method for a computing system to evaluate a fit of an embedding model for an evaluation dataset. The method includes accessing a reference embedding space generated by applying an embedding model to a reference dataset; obtaining a plurality of views of the reference embedding space; determining a distance threshold using the plurality of views of the reference embedding space; obtaining an evaluation embedding space generated by applying the embedding model to an evaluation dataset; determining a distance value representing a distance between the evaluation embedding space and the reference embedding space; comparing the distance value with the distance threshold; and based on the comparison, determining a level of fitness of the embedding model for the evaluation dataset.

This has a technical advantage in the fitness of an embedding model for an evaluation dataset can be automatically determined by a computing system, and thus early detection can be achieved when an embedding model is not suitable for use with an input dataset. Early detection prevents degraded performance of downstream tasks that rely on the embedding space generated by the input dataset. Furthermore, this detection may be achieved even without having access to the embedding model itself, and without having access to the reference and evaluation datasets.

Notwithstanding, the larger principles described herein still work well if the computing system does have access to the reference dataset or the embedding model. In this case, the computing system may access the reference embedding space by feeding the reference data into the embedding model. This has an advantage in that the principles can still be employed if the computing system does not initially have access to the reference embedding space. It further has the advantage in the correlation between the reference dataset and the reference embedding space is self-validated since the computing system knows that the reference embedding space was truly generated by providing the reference dataset to the embedding model.

Also, the larger principles described herein still work well if the computing system does have access to the evaluation dataset. In this case, the computing system may access the evaluation embedding space by feeding the evaluation data into the embedding model. This has an advantage in that the principles can still be employed if the computing system does not initially have access to the evaluation embedding space. It further has the advantage in the correlation between the evaluation dataset and the evaluation embedding space is self-validated since the computing system knows that the evaluation embedding space was truly generated by providing the evaluation dataset to the embedding model.

As previously mentioned, the reference embedding space and the evaluation embedding space may have more than three dimensions, and perhaps may have tens or hundreds of dimensions. A machine can readily create such a high-dimensional representation and operate on it, whereas a human being cannot even visualize much more than three dimensions. The use of larger numbers of dimensions permits for a more refined technical representation of aspects of the input data items. Accordingly, more precise and accurate downstream tasks may be taken by the downstream task models. As an example, classification, anomaly detection, regression, and so forth, may all be improved.

Several examples of how method 400 may be performed will now be described with respect to several pseudocode snippets.

In the first pseudocode example, let X be a reference n-dimensional embedding space, and Y be an evaluation n-dimensional embedding space. Note that the number of points in the point cloud of each of the embedding spaces may be different. The pseudocode of one example analysis is as follows:

1. For growing noise levels, compute samples of performance values C(X, noise, **).
a. At each noise level, collect multiple view and their associated performance values.
b. Stop collecting when a particular statistic of the performance values (e.g., median, average, and so forth) crosses criteria threshold.
c. Identify noise level associated with crossing criteria threshold. Call this noise_star.

2. At noise_star, several times, perturb X (yielding X_noise) and compute distance measurement D(X, X_noise). a. Report the statistical value of the distance measurements. Call this distance_star.

3. Compute distance measure D(X, Y).

4. Report whether D(X, Y)<distance_star.
a. If true, distributions are similar, and no shift has occurred.
b. If false, distributions are different, due to significant shift.

Here, there are two views on the reference embedding space that are used. The first view is the entire reference embedding space X (although a randomly selected subsample of the reference embedding space X would also work). The second view is a perturbation of the first view of the embedding space X. In other words, if the first view is the entire reference embedding space, the second view is a perturbation of the reference embedding space X. In the above example, the second view is a perturbation of the reference embedding space using a given level of noise. Here, we can also specify a criteria threshold.

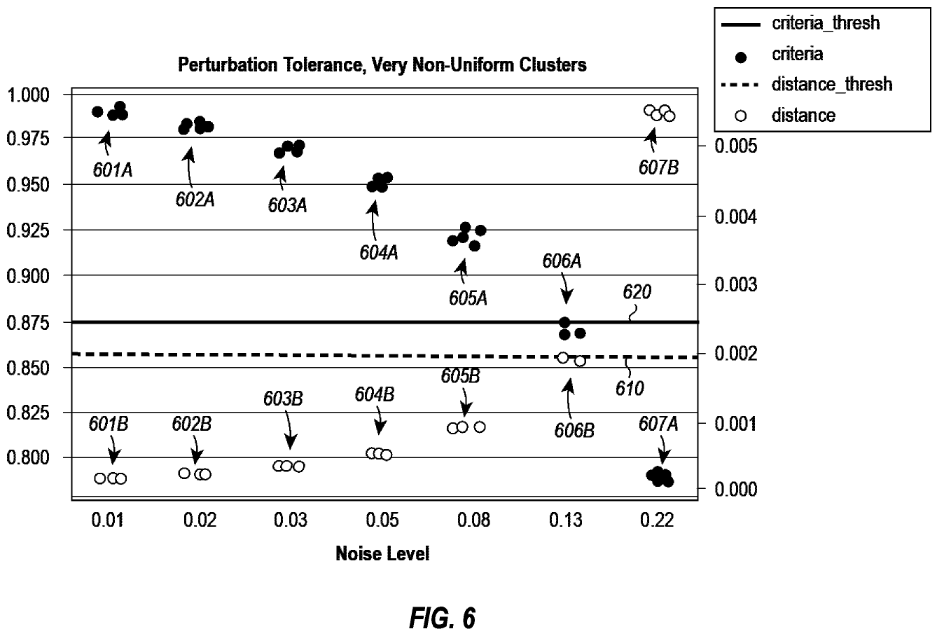

The value of noise_star is determined in step 1 of the pseudocode, which will now be described with respect to FIG. 6. Here, the user specifies criteria and a corresponding threshold. In step 1, for growing noise levels, samples of performance values C(X, noise, **) are computed.

In FIG. 6, for example, at the first noise level 0.01 performance values (referred to in FIG. 6 a “Criteria Value”) are computed several times resulting in performance cluster 601A. The noise 0.01 and associated performance cluster values 601A are then collected in step 1a. As a side note, associated distance measures are represented as 601B. A distance is a distribution shift metric. The distribution shift metric can be any metric that increases as performance criteria decreases, and vice versa. The collecting stops when a suitable statistic (e.g., median) of the performance cluster values crosses a criteria threshold. In this example, suppose that the criteria threshold is 0.875 (which is represented by the line 620 in FIG. 6) In the following, the statistic will be a median by way of example only. Clearly, the median of the performance cluster values 601A is well above 0.875 (around 0.99 or so). Accordingly, step 1 repeats for a larger noise level.

The second noise level is 0.02. Criteria values at noise level 0.02 are calculated resulting in performance cluster values 602A. The median of the performance cluster values 602A is still well above the criteria threshold of 0.875 (about 0.98), and thus the noise value 0.02 and associated performance cluster values 602A are again collected. Associated distance measures are represented as 602B. Note that as distance increases, performance criteria decreased. Because the median of the performance cluster values 602A has not yet crossed the criteria threshold of 0.875, the next noise level is evaluated.

The third noise level is 0.03. Criteria values at noise level 0.03 are calculated resulting in performance cluster values 603A. The median of the performance cluster values 603A is still well above the criteria threshold of 0.875 (about 0.97), and thus the noise value 0.03 and associated performance cluster values 603A are again collected. Associated distance measures are represented as 603B, which have increased from the distance measures 602B. The next noise level is evaluated.

The fourth noise level is 0.05. Criteria values at noise level 0.05 are calculated resulting in performance cluster values 604A. The median of the performance cluster values 604A is still above the criteria threshold of 0.875 (about 0.95), and thus the noise value 0.05 and associated performance cluster values 604A are again collected. Associated distance measures are represented as 604B, which have increased from the distance measures 603B. The next noise level is evaluated.

The fifth noise level is 0.08. Criteria values at noise level 0.08 are calculated resulting in performance cluster values 605A. The median of the performance cluster values 605A is above the criteria threshold of 0.875 (about 0.925), and thus the noise value 0.08 and associated performance cluster values 605A are again collected. Associated distance measures are represented as 605B, which have increased from the distance measures 604B. The next noise level is evaluated.

The sixth noise level is 0.13. Criteria values at noise level 0.13 are calculated resulting in performance cluster values 606A. The median of the performance cluster values 606A is slightly above the criteria threshold of 0.875 (about 0.876), and thus the noise value 0.13 and associated performance cluster values 606A are again collected. Associated distance measures are represented as 606B, which have increased from the distance measures 605B. The next noise level is evaluated.

The seventh noise level is 0.22. Criteria values at noise level 0.22 are calculated resulting in performance cluster values 607A. The median of the performance cluster values 607A is below the criteria threshold of 0.875 (about 0.79).

Accordingly, as per step 1b, and the noise value 0.22 and associated performance cluster values 607A are not collected. As per step 1c, the noise level associated with crossing the criteria threshold was 0.13 (the last collected noise level), which is designated in step 1c as noise_star.

As per step 2, the reference embedding space is perturbed by noise_star (in this example 0.13) several times. Any of the perturbed versions of the reference embedding space may be regarded as the second view of the reference data structure. Collectively, the reference embedding space X and all of the perturbed reference embedding spaces may be regarded as a plurality of views of the reference embedding space.

In step 2, the distance between the original reference embedding space and the perturbed reference embedding space is calculated for each of the perturbed embedding spaces. The median (or other suitable statistic) of all of these distance measures is then called distance_star. This distance_star is an example of the fitness threshold determined from the several views of the reference embedding space. In FIG. 6, the example distance_star is represented by line 610, which represents the approximate median of the distance measures 606B. Although the distance measures for other noise levels 601B, 602B, 603B, 604B, 605B and 607B are also shown in FIG. 6, these in reality do not need to be calculated, but are just illustrated to show what distance measures could be. The distance measures are only calculated once noise_star is found.

The distance value (computed using e.g., the energy distance metric) between the reference embedding space and the evaluation embedding space is then calculated in step 3. The distance value between the reference embedding space and the evaluation embedding space is then compared against the distance threshold (distance star) in this example. Based on this comparison, the embedding model is viewed as fit (in step 4a) or unfit (in step 4b). For example, if the distance between the reference embedding space and the evaluation embedding space is more than represented by line 610 in FIG. 1, the embedding model is determined to be unfit for the evaluation dataset. On the other hand, if the distance between the reference embedding space and the evaluation embedding space is less than represented by line 610 in FIG. 1, the embedding model is determined to be fit for the evaluation dataset.

In a second pseudocode example, the two views of the reference embedding space are subsamples of the reference embedding space. The pseudocode example is as follows:

1. Several times, subsample X to get x′ and x″ and compute the distance measure D(x′, x″).
a. Note the suitable statistic (e.g., median) among these distances as D_xx.

2. Several times, subsample x′ from X and y′ from Y, and compute the distance measure D(x′, y′).
a. Note the suitable statistic (e.g., median) among these distances as D_xy.

3. Report whether D_xy−D_xx>eps.
a. If true, distributions are different, due to significant shift.
b. If false, distributions are similar, and no shift has occurred.

Given the reference embedding space X and the evaluation embedding space Y, suppose two independent subsets are drawn from X. Call them x′ and x″, respectively (which is an example of the plurality of views of the reference embedding space). Suppose also that a subset is drawn from Y, which we will call y′. This test detects a distribution shift if the distance between x′ and y′ is within a threshold of distance between x′ and x″.

Specifically, for a certain distance measure D, the test detects a distribution shift if D(x′, y′)−D(x′, x″)>eps, where eps is some positive value. In effect, this test is whether the distance between the subset of the evaluation embedding space and subset of reference embedding space is greater than the distance between the different subsets of the reference embedding space by some factor eps. The threshold “eps” can be defined by a user, or if not provided, it can be set automatically based on a statistic such as but not limited to standard deviation of distances among subsamples of dataset X.

In accordance with the principles described herein, a reference embedding space is compared with an evaluation embedding space to determine if there is sufficient distribution shift that the embedding model is likely no longer fit for use with the evaluation dataset. To help a human user have user confidence that this is the case, the reference embedding space and the evaluation embedding space may be visualized to a user.

Because the principles described herein are performed in the context of a computing system, some introductory discussion of a computing system will be described with respect to FIG. 7. Computing systems are now increasingly taking a wide variety of forms. Computing systems may, for example, be handheld devices, appliances, laptop computers, desktop computers, mainframes, distributed computing systems, data centers, or even devices that have not conventionally been considered a computing system, such as wearables (e.g., glasses). In this description and in the claims, the term “computing system” is defined broadly as including any device or system (or a combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 7, in its most basic configuration, a computing system 700 includes at least one hardware processing unit 702 and memory 704. The processing unit 702 includes a general-purpose processor. Although not required, the processing unit 702 may also include a field programmable gate array (FPGA), an application specific integrated circuit (ASIC), or any other specialized circuit. In one embodiment, the memory 704 includes a physical system memory. That physical system memory may be volatile, non-volatile, or some combination of the two. In a second embodiment, the memory is non-volatile mass storage such as physical storage media. If the computing system is distributed, the processing, memory and/or storage capability may be distributed as well.

The computing system 700 also has thereon multiple structures often referred to as an “executable component”. For instance, the memory 704 of the computing system 700 is illustrated as including executable component 706. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods (and so forth) that may be executed on the computing system. Such an executable component exists in the heap of a computing system, in computer-readable storage media, or a combination.

One of ordinary skill in the art will recognize that the structure of the executable component exists on a computer-readable medium such that, when interpreted by one or more processors of a computing system (e.g., by a processor thread), the computing system is caused to perform a function. Such structure may be computer readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hard coded or hard wired logic gates, that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data. If such acts are implemented exclusively or near-exclusively in hardware, such as within a FPGA or an ASIC, the computer-executable instructions may be hard-coded or hard-wired logic gates. The computer-executable instructions (and the manipulated data) may be stored in the memory 704 of the computing system 700. Computing system 700 may also contain communication channels 708 that allow the computing system 700 to communicate with other computing systems over, for example, network 710.

While not all computing systems require a user interface, in some embodiments, the computing system 700 includes a user interface system 712 for use in interfacing with a user. The user interface system 712 may include output mechanisms 712A as well as input mechanisms 712B. The principles described herein are not limited to the precise output mechanisms 712A or input mechanisms 712B as such will depend on the nature of the device. However, output mechanisms 712A might include, for instance, speakers, displays, tactile output, virtual or augmented reality, holograms and so forth. Examples of input mechanisms 712B might include, for instance, microphones, touchscreens, virtual or augmented reality, holograms, cameras, keyboards, mouse or other pointer input, sensors of any type, and so forth.

Embodiments described herein may comprise or utilize a special-purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general-purpose or special-purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general-purpose or special-purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmission media can include a network and/or data links which can be used to carry desired program code means in the form of computer-executable instructions or data structures and which can be accessed by a general-purpose or special-purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RANI within a network interface module (e.g., a “NIC”), and then be eventually transferred to computing system RANI and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general-purpose computing system, special-purpose computing system, or special-purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing system, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicate by the appended claims rather than by the foregoing description. All changes which come within the meaning and range of equivalency of the claims are to be embraced within their scope.

What is claimed is:

1. A computing system comprising:
one or more processors; and
one or more computer-readable media having thereon computer-executable instructions that are structured such that, if executed by the one or more processors, the computing system would be configured to evaluate a fit of an embedding model for an evaluation dataset, by being configured to perform the following:
access a reference embedding space generated by applying an embedding model to a reference dataset;
obtain a plurality of views of the reference embedding space;
determine a distance threshold for a distance metric using the plurality of views of the reference embedding space;
obtain an evaluation embedding space generated by applying the embedding model to an evaluation dataset;
determine a distance value representing distance between the evaluation embedding space and the reference embedding space;
compare the distance value with the distance threshold; and
based on the comparison, determine a level of fitness of the embedding model for the evaluation dataset.

2. The computing system in accordance with claim 1, a first view of the plurality of views of the reference embedding space being a sub sample of or the entire reference embedding space, the second view of the plurality of views of the reference embedding space representing a perturbation of the first view of the reference embedding space.

3. The computing system in accordance with claim 1, the distance value being a distribution shift value between the reference embedding space and the evaluation embedding space.

4. The computing system in accordance with claim 1, the determining of the distance threshold based on computing the value of an aggregate statistic of the distance metric for a plurality of views of the reference embedding space generated using a highest perturbation level that satisfies a user-specified performance criteria.

5. The computing system in accordance with claim 4, the performance criteria being a value of a function that decreases as the distance metric increases.

6. The computing system in accordance with claim 1, a first view of the plurality of views of the reference embedding space being a first subsample of the reference embedding space, the second view of the plurality of views of the reference embedding space representing second subsample of the reference embedding space.

7. The computing system in accordance with claim 1, the reference dataset comprising a training dataset.

8. A computer-implemented method for a computing system to evaluate a fit of an embedding model for an evaluation dataset, the method performed by the computing system comprising:
accessing a reference embedding space generated by applying an embedding model to a reference dataset;
obtaining a plurality of views of the reference embedding space;
determining a distance threshold for a distance metric using the plurality of views of the reference embedding space;
obtaining an evaluation embedding space generated by applying the embedding model to an evaluation dataset;
determining a distance value representing distance between the evaluation embedding space and the reference embedding space;
comparing the distance value with the distance threshold; and
based on the comparison, determining a level of fitness of the embedding model for the evaluation dataset.

9. The method in accordance with claim 8, a first view of the plurality of views of the reference embedding space being a subsample of or the entire reference embedding space, the second view of the plurality of views of the reference embedding space representing a perturbation of the first view of the reference embedding space.

10. The method in accordance with claim 8, the distance value being a distribution shift value between the reference embedding space and the evaluation embedding space.

11. The method in accordance with claim 8, the determining of the distance threshold based on computing the value of an aggregate statistic of the distance metric for a plurality of views of the reference embedding space generated using a highest perturbation level that satisfies a user-specified performance criteria.

12. The method in accordance with claim 11, the performance criteria being a value from a function that decreases as the distance metric increases.

13. The method in accordance with claim 8, a first view of the plurality of views of the reference embedding space being a first subsample of the reference embedding space, the second view of the plurality of views of the reference embedding space representing second subsample of the reference embedding space.

14. The method in accordance with claim 8, the reference dataset comprising a training dataset.

15. The method in accordance with claim 8, the level of fitness comprising whether or not the embedding model is acceptable for use with the evaluation dataset.

16. The method in accordance with claim 8, the obtaining of the evaluation embedding space being performed by the computing system applying the reference embedding model to the evaluation dataset.

17. The method in accordance with claim 8, the obtaining of the reference embedding space being performed by the computing system applying the reference embedding model to the reference dataset.

18. The method in accordance with claim 8, the reference embedding space and the evaluation embedding space each having greater than three dimensions.

19. The method in accordance with claim 18, the reference embedding space and the evaluation embedding space each having a same number of dimensions and same corresponding dimensions.

20. A computer program product comprising one or more computer-readable storage media having thereon computer-executable instructions that are structured such that, if executed by one or more processors of a computing system, would cause the computing system to be configured to evaluate a fit of an embedding model for an evaluation dataset, by being configured to perform the following:
access a reference embedding space generated by applying an embedding model to a reference dataset;
obtain a plurality of views of the reference embedding space;
determine a distance threshold for a distance metric using the plurality of views of the reference embedding space;
obtain an evaluation embedding space generated by applying the embedding model to an evaluation dataset;
determine a distance value representing distance between the evaluation embedding space and the reference embedding space;
compare the distance value with the distance threshold; and
based on the comparison, determine a level of fitness of the embedding model for the evaluation dataset.
